(19) United States
(12) Patent Application Publication
(10) Pub. No.: US 2006/0280902 A1
(43) Pub. Date: Dec. 14, 2006

(54) Carpet cushion

(76) Inventors: A. Dale Otteson, Stillwater, MN (US); Bradley W. Eaton, Woodbury, MN (US); Troy K. Ista, River Falls, WI (US); Suzanne M. Nelson, Hugo, MN (US); Jason J. Butenschoen, Minneapolis, MN (US)

Correspondence Address: 3M INNOVATIVE PROPERTIES COMPANY, PO BOX 33427, ST. PAUL, MN, 55133-3427, US

(21) Appl. No.: 11/449,082

(22) Filed: Jun. 8, 2006

Related U.S. Application Data
(60) Provisional application No. 60/688,828, filed on Jun. 9, 2005.

(51) Int. Cl. B32B 27/12; B32B 5/24; B32B 3/26; D03D 27/00

(52) U.S. Cl. 428/95; 442/121; 442/123; 442/221; 428/304.4

(57) ABSTRACT

A carpet cushion comprisings a barrier layer bonded to a base layer wherein the carpet cushion exhibits a Static Repellency Rating of at least 0, a Hydrostatic Head of at least 20 centimeters water, and an MVTR (at 70° F. and 50% RH) of at least 1000.

### CROSS-REFERENCE TO RELATED APPLICATION

This application claims priority to U.S. Provisional Patent Application No. 60/688,828, filed Jun. 9, 2005.

### FIELD

The present invention relates to a carpet cushion for use under a carpet or rug.

### BACKGROUND

Most residential carpeting is installed over an underlayment referred to as a carpet cushion, sometimes referred to as a pad or padding. The carpet cushion provides additional softness and comfort over the carpeting alone, increases thermal and sound insulation of the floor covering, and increases the durability and appearance retention of the carpeting. Many carpet manufacturers recommend installation of new carpeting over new carpet cushion.

Many current carpet cushions are made from foam rubber, either as “prime” foam (i.e., new foam in a substantially continuous sheet) or as “re-bond” foam (i.e., new or recycled foam and/or foam rubber shredded to a small size and then re-adhered together to form a continuous sheet). Other materials that are used include various fibrous mats and webs.

Carpet cushions are typically provided with an upper layer which provides mechanical stability and tear resistance to the fragile padding. In addition, this layer provides a smooth surface to facilitate installation of the carpet. In some constructions, this upper surface is a continuous film designed to provide resistance to moisture transfer. In many, if not most, constructions the upper layer is intended primarily as a bonding device and is pierced or “burned through” during assembly, rendering it liquid permeable.

Water resistant carpet underlays provide a way to clean spills on carpet more thoroughly by helping to contain the spill above the padding or floor. If a spill is not removed from under the carpet, the spill will allow the growth of mold, mildew, and bacteria. Not only may the padding and underlying flooring, e.g., wood, deteriorate as a result, but such conditions are conducive to the formation of odors and allergens. Spills on fitted or wall-to-wall carpeting are particularly insidious since detection and prevention of the seepage into the padding following a spill is typically impractical with large or fitted carpets. A spill on broadloom carpeting often puddles on the padding or underlying flooring where it can not be removed by cleaning. This spill then accelerates the growth of mold, mildew and odors.

U.S. Pat. Nos. 5,601,910 and 5,763,040 (Murphy) describe processes for chemically treating an underlay with a repellent finish to make it substantially impermeable to spills. By careful selection of both the water repellent finish and adhesive, the underlay was adhered to the underside of the carpet creating a barrier substantially impervious to spills.

It has been suggested to make water impermeable carpeting using sheets of plastic, such as polyethylene and poly(ethylene/vinyl acetate), that are laminated to the bottom sided of the carpet. However, such backings are expensive, create manufacturing difficulties, and prevent desirable breathability (air permeability) of the carpet. Thus the growth of mold and mildew are not prevented.

Further, in actual practice it is difficult, if not impossible, to apply the carpet/cushion so that the barrier layer on the cushion remains completely impermeable. Seams between sections of cushion, fasteners such as staples, and damage to the carpet caused by carpet installation and the tools commonly used in that process are all sites at which a liquid spill can penetrate even a cushion protected by what was intended to be an “impermeable” barrier. In these circumstances the would-be impermeable barrier becomes a liability since it substantially reduces the ability to remove or evaporate spilled liquids from the construction.

The need exists for carpet cushion that provides a desirable combination of resistance to liquid penetration such as from spills and carpet cleaning in conjunction with effective drying properties.

### SUMMARY OF INVENTION

It would be advantageous if an improved barrier material could be fabricated that would provide similar resistance to pressure and static wetting as continuous film barriers while at the same time constructing the barrier so that it is air permeable such that moisture which might lead to mold or mildew is not trapped beneath it. The present invention provides a superior carpet cushion having liquid impermeability while maintaining vapor breathability.

In brief summary, a carpet cushion of the invention comprises a fibrous barrier layer bonded to a base layer. The barrier layer provides substantial liquid repellency to protect the underlying base layer from penetration of spilled liquid. The carpet cushion exhibits a heretofore unparalleled permeability to air flow that enhances air flow through the carpet cushion, thereby facilitating drying of liquids that may have penetrated into or through the carpet cushion from spills.

Carpet cushions of the invention provides a surprising combination of properties including simultaneously providing high resistance to liquid moisture penetration (i.e., repellency) and high breathability. As a result of the high repellency, carpet cushion of the invention provides resistance to penetration of spills while its high breathability permits effective drying of liquid that has penetrated the flooring. As a result, carpet cushion of the invention provides enhanced resistance to staining bacteria, mold and mildew formation, and odor formation. Carpet cushion of the invention is particularly well suited for use with residential type carpeting or rugs.

### DETAILED DESCRIPTION

In brief summary, a carpet cushion of the invention comprises a fibrous barrier layer bonded to a base layer wherein the carpet cushion exhibits a Static Water Repellency Rating of at least 0, preferably at least 1, and most preferably at least 2, a Water Resistance (Hydrostatic Head) of at least 15, preferably at least 40, and most preferably at least 50, and an MVTR (at 70° F. and 50% RH) of at least 1000, preferably at least 2000, and most preferably at least 3000, grams/yard²/24 hours. Typically, a carpet cushion of the invention will have an Air Permeabilty of at least 15, preferably at least 30, and most preferably at least 50, ft³ air/minute/ft² area (CFM/ft²).

The present invention provides a carpet cushion or underlay comprising a composite of a fibrous barrier layer having opposite first and second planar sides, and base layer having opposite first and second planar sides. The barrier layer is bonded to the base layer. If desired, the barrier layer, base layer, or both may be substantially free of fluorochemical, e.g., conventional repellent finishes.

Carpet cushion of the invention may be wound into roll form or handled in sheet form as desired.

The term “carpet cushion” as defined by The Carpet and Rug Institute (CRI), located in Dalton Ga., means any kind of material placed under carpet to provide resiliency, support, and noise reduction when walked upon (CRI 105 “Residential Carpet Installation Standards”).

The term “padding” or “pad” is considered synonymous with “carpet cushion”.

Barrier Layer

The barrier layer comprises a fibrous material. The fibrous substrate component of the breathable liquid-impermeable underlay is any woven or non-woven fabric or web, and is preferably a light non-woven fabric, selected from the group consisting of polyester, polyolefin, polyamide, poly(trimethylene terephthalate) synthetic fibers, natural fibers, bicomponent fibers, cellulosic fibers, wool, cotton, acrylic, jute, and copolymers and blends thereof. By the term “cellulosic” is meant fibrous cellulose-based products made from wood or other plants. Bicomponent fibers include fibers made of two polymers, blends of polymeric fibers with natural or synthetic fibers, and blends of natural and synthetic fibers. Suitable nonwoven materials include spunbonded webs, scrims, carded webs, flashspun webs, or nonwoven sheets comprised of blends of polymer fibers. Preferred nonwoven materials are spunbonded or spunbonded-meltblown-spunbonded polyolefin materials.

Typically, the barrier layer of carpet cushions of the invention will have a Static Water Repellency of at least 0 and a Hydrostatic Head of at least 15 centimeter water.

It has now been surprisingly discovered that many fabrics may be applied to a base layer as a barrier layer to provide a desirably high level of liquid hold out or non-penetration while yielding a construction with a desired high air permeability.

The greatly enhanced ability of the barrier layers of carpet cushions of the invention to breathe or transpire moisture vapor is a significant and valuable improvement over currently available constructions. When carpet cushion is installed over a wood (wood, plywood, particle board) floor or underlayment, it is usually secured in place with staples which both pierce the barrier layer and compact the surrounding cushion causing a depression in which free liquid can collect. High performance carpet cushion instructions often specify sealing the seams with something like duct tape, but this is often not done or not done carefully. Under normal circumstances, liquid spills are thus likely to penetrate the cushion, no matter how impermeable the original barrier.

In new construction, the underlayment is often damp or still contains residual moisture from manufacture. Concrete floors are often slightly damp, either because of seepage or condensation. Regardless of the source, moisture trapped within or beneath the cushion can lead to the growth of bacteria, mold, mildew, or even rot. Increasing the air flow through the padding and increasing drying rates will help reduce moisture caused problems. High air flow through the padding will also serve to increase drying rates of the supported carpeting, either through normal evaporation or with vacuum extraction. For these reasons, a nonwoven barrier layer offers many advantages over most current carpet cushion constructions.

If desired, the barrier layer may be printed with logos, instructions, warranty information, etc.

If desired, the barrier layer may further comprise or have been treated to impart desired characteristics, e.g., materials to further inhibit or suppress the growth of mold, mildew, or bacteria, or to prevent or absorb odor.

Base Layer

The base layer is a resilient support layer that provides much of the desired cushion effect to the overlying rug or carpet.

Carpeting requires a solid foundation to increase comfort and durability, reduce noise, and provide insulation. Commercially available residential carpet padding is typically from about ⅜ to ⅝ inch thick.

In the invention, the base layer can be made from foam rubber, either as “prime” foam (i.e., new foam in a substantially continuous sheet) or as “re-bond” foam (i.e., new or recycled foam and/or foam rubber shredded to a small size and then re-adhered together to form a continuous sheet). In addition, the base layer may be made from other resilient materials such as is known in the art, e.g., it can be constructed of various forms of rubber and urethane, felted combinations of hair and jute, and fiber.

The thin sheets of cushion foam are, by themselves, mechanically fragile, and would be easily damaged or torn during installation. In addition, the foam tends to be a non-slip surface, so it would make installation of the carpeting more difficult. One of the advantages of the present invention is that the barrier layer material tends to impart greater tensile strength and tear resistance to the carpet cushion making it easier to handle than the base layer alone. In some instances it will be desired to incorporate a reinforcing scrim in the carpet cushion, typically between the barrier layer and base layer, in order to impart improved mechanical stability and properties to the carpet cushion.

The base layer of carpet cushions of the invention will typically be from about ⅜ to ⅝ inch thick though thinner or thicker layers may be used if desired.

If desired, the base layer may further comprise or have been treated to impart desired characteristics, e.g., materials to prevent or suppress the growth of mold, mildew, or bacteria, or to prevent or absorb odor.

Bonding

The barrier layer and base layer are bonded together. This may be achieved with self adhesion, e.g., via heat lamination, or using an optional intermediate bonding material, e.g., a discontinuous web of adhesive which might be pressure sensitive or activated in some fashion. Suitable bonding material can be readily selected by those skilled in the art without difficulty. The bonding material should not unduly interfere with the desired vapor permeability of the carpet cushion. Accordingly, it will typically be in discontinuous form.

Installation

The padding is laid and attached to the flooring conventionally, e.g., for wood flooring with metal staples placed about every 8 inches (20 cm) along the perimeter to prevent the padding from moving, buckling, or tearing during or after installation.

Carpet cushion of the invention may be made, transported, and used in any desired configuration, e.g., mats or sheets, wound into roll form, etc.

### EXAMPLES

### Test Methods

Static Water Repellency Test

This test measures the resistance of substrates to water based challenges. The samples are challenged with water and water/isopropanol (IPA) mixtures, with IPA concentrations increasing in increments of 10% (wt.). For convenience, the solutions are named according to the concentration of IPA: 100% water (0% IPA) is a “0,” 10% IPA is a “1,” 20% IPA is a “2,” etc.

Five separate drops of a test fluid are gently placed on the upper surface of the barrier layer of the carpet cushion sample spaced several centimeters (cm) apart. After 15 seconds, if 60% of the drops (3) have not wet the barrier layer (i.e., remained substantially beaded), the sample is graded as a “pass” for that fluid. If 60% (or more) of the drops have wet the barrier layer, the sample is graded as a “fail” for that fluid. The level of static repellency is indicated by the number of the fluid with the highest concentration of IPA that was given a “pass” grade. If the barrier layer fails 100% water, it is rated a “fail” or given a numerical rating of “−1.” A more detailed description of the test is written in the 3M Water Repellency Test II: Water/Alcohol Drop Test (Doc. # 98-0212-0721-6).

Water Resistance: Hydrostatic Pressure Test

Hydrostatic pressure was measured according to the AATCC 127-1995 test method, using a pressure tester from the Alfred Suter Co., Inc., Ramsey, N.J. In this test, the carpet cushion sample is mounted so that the upper surface of the barrier layer is covered with water and the lower surface is open to the air at atmospheric pressure. If the water does not wet through at zero pressure differential, the pressure of the water on the upper surface of the sample is gradually increased until water is forced through the sample or until the pressure is raised to the limits of the apparatus. For this procedure and apparatus, the pressure differential across the sample is given by the height of a water column, measured in cm, above the surface of the sample. The higher the hydrostatic pressure result, the less likely it is that water will be forced through the sample by pressure such as, for example, someone walking across a wet area of a carpet.

Simulated Walk-on Wetting Resistance Test

The walk-on test is intended to simulate the circumstance in which a liquid spill, either unnoticed or ignored, is allowed to soak into a carpet, and then is subjected to foot-step pressure while still wet. Typical residential carpeting is made with a porous, often heavily filled, latex backing. The carpet is capable of absorbing large quantities of spilled liquids. Spilled liquids also tend to spread within the carpet and backing by wetting (wicking), so that free liquid is quickly absorbed in the structure of the carpet. A typical spill of, for example, an 8 ounce glass of water would quickly spread over an area that would allow it to be absorbed. The ability of the carpeting to absorb liquid varies with the carpet and backing construction. For the carpet used in this testing, it was determined that 130 grams of water poured on the center of the sample would be completely absorbed in about 10 minutes, and wick outward fairly evenly to wet a circular area about 12 inches in diameter. To ensure that the amount of liquid used did not exceed the ability of the sample to absorb and distribute it, testing was done on the basis of 100 grams of water per square foot of carpet. When smaller samples were used, the quantity of water applied was adjusted on that basis. The sample size used for each test was 12 inches×10 inches (30.5 cm×25.4 cm), and the amount of water applied was 83 grams.

Samples of the carpet cushions were weighed and placed beneath weighed carpet pieces of exactly the same size and shape as the cushion so that the barrier layer was in contact with the carpet backing. The water “spill” was applied to the carpet and allowed to stand for 30 minutes. The operator then stepped on, then back off, of the sample two times. To ensure consistency, the same operator performed all of the walk-on testing. The carpet and the cushion samples were then reweighed to determine the distribution of water. Typically, a small amount of water was lost through evaporation on standing, and through transfer to the operator's shoes.

Nonwoven Materials

The following nonwoven materials were used as barrier layers in the examples.

Nonwoven #1 was a 1.0 ounce per square yard (“osy”) polypropylene spunbond-meltblown-spunbond (SMS), available from BBA Fiberweb, Brentwood, Tenn.

Nonwoven #2 was a 1.4 osy polypropylene spunbond-meltblown-spunbond (T0505), available from BBA Fiberweb, Brentwood, Tenn.

Nonwoven #3 was an 85.5 grams per square meter (“gsm”) polyester spunbond (TN 1663), available from Precision Custom Coatings LLC, Totowa, N.J.

Nonwoven #4 was an 85.5 gsm polyester spunbond (TN 1668), available from Precision Custom Coatings LLC, Totowa, N.J.

Nonwoven #5 was a 1.25 osy polypropylene spunbond-meltblown-spunbond (SMS), (125MLPO09U) available from BBA Fiberweb, Brentwood, Tenn.

Nonwoven #6 was a 1.8 osy polypropylene spunbond-meltblown-spunbond (SMS), available from BBA Fiberweb, Brentwood, Tenn.

### Examples 1-7

Prototype carpet cushion constructions were made by laminating nonwoven materials to standard 7/16 inch thick, 8 pound per cubic foot rebond foam sheet with a hot-melt polyolefin adhesive nonwoven web (available from Spunfab, Ltd., Cuyahoga Falls, Ohio) using a conventional hot-roll calendar laminator. These samples were tested for static water repellency, water resistance, and simulated walk-on wetting resistance as described in the above test methods. The performance data are given in Table 1.

Samples of commercially available, branded carpet cushions (Odor Eater™ carpet cushion having a moisture barrier layer and Stainmaster™ carpet cushion featuring the DuPont™ Hytrel® breathable moisture barrier layer) were also tested for static water repellency, water resistance, and simulated walk-on wetting resistance. The Odor Eater™ sample was a prime foam type carpet cushion rather than rebond type carpet cushion. The barrier layer appeared to be a continuous film which had been pierced or “burned through” during manufacturing so that the final construction appeared to be a surface that was not impermeable to liquid, but was instead perforated unevenly with holes that were small enough to hold out static drops. The Stainmaster™ sample was evaluated for walk-on repellency as rebond construction. The barrier for this construction appeared to be combination of a nonwoven over a continuous membrane. Microscopic examination of sections of the surface did not reveal any voids of the type observed in the Odor Eater™ construction. The performance data for these constructions are also given in Table 1.

Performance is reported as percent of applied water retained in the carpet cushion (in each case an average of 4 to 6 replicates).

TABLE 1

| | Nonwoven | Adhesive Web Weight | Static Water | Water | Dry Wt. (g) | Wet Wt. (g) | Δ (g) | % Retain |
|---|---|---|---|---|---|---|---|---|
| Example | Type | (grams/square yard) | Repellency | Resistance (cm) | Cushion | Cushion | Cushion | (H₂O in Cushion) |
| 1 | #1 | 0.25 | 2 | 19.7 | 110.8 | 112.1 | 1.3 | 1.6 |
| 2 | #1 | 0.45 | 2 | 19.6 | 117.8 | 118.7 | 0.9 | 1.1 |
| 3 | #4 | 0.45 | 2 | 24.2 | 111.2 | 111.9 | 0.7 | 0.8 |
| 4 | #3 | 0.45 | 2 | 23.8 | 115.7 | 116.7 | 1 | 1.2 |
| 5 | #2 | 0.25 | 2 | 43.7 | 92.8 | 93.7 | 0.9 | 1.1 |
| 6 | #2 | 0.45 | 2 | 76.2 | 98.3 | 99.3 | 1 | 1.2 |
| 7 | #2 | 0.45 | 2 | 83. | 105.8 | 106.6 | 0.8 | 1.0 |
| Odor Eater ™ | | | 10 | 14.6 | 67.1 | 68.1 | 1 | 1.2 |
| (prime foam) | | | | | | | | |
| Stainmaster ™ | | | 4 | 23.9 | 104.3 | 104.7 | 0.4 | 0.5 |
| (rebond foam) | | | | | | | | |

All the above examples exhibited the desired balance of water repellency and water resistance. Even though the commercially available carpet cushions exhibited higher water repellency than the example carpet cushions made with a nonwoven barrier, there appeared to be no significant difference in the simulated walk-on wetting resistance performance.

### Examples 8 And 9

Examples 8 and 9 were prepared according to Examples 1-7 except that the nonwovens used for the barrier layer in the carpet cushion construction were Nonwoven #5 and Nonwoven #6, respectively.

Moisture Vapor Transmission

Moisture vapor transmissionr rates (MVTR) were measured for Example 5 and for the Odor Eater™ and the Stainmaster™ commercial carpet cushion products. The MVTR (upright cup) was measured according to ASTM E 96 Standard Test —Water Vapor Transmission, with the following modifications. Samples for testing were made by punching circles of the complete cushion construction including the foam and the barrier layer. The barriers were masked with adhesive tape so as to have identical effective surface areas. The open foam edges were masked continuously with the surface masking, and continuously to the water reservoirs to prevent moisture loss at any point except the test surface. Testing was carried out in 70° F. constant temperature rooms at approximately 70% RH and also at approximately 50% RH. A fan was used to mechanically convect air over the test surfaces. Moisture loss was measured at intervals over a 24 hour period, and was found to be nearly linear with some flattening in the last 3-4 hours. The moisture vapor transmission rates (in grams/yard²) for a 24 hour period are reported in Table 2.

TABLE 2

| | MVTR | MVTR |
|---|---|---|
| Sample | 70° F., 70% RH | 70° F., 50% RH |
| Example 5 | 3150 | 5233 |
| Odor Eater ™ | 2236 | 3141 |
| (with prime foam) | | |
| Stainmaster ™ | 1710 | 1827 |
| (with rebond foam) | | |

The Example 5 carpet cushion construction having the nonwoven barrier layer exhibited significant improvement in moisture removal from beneath and through the cushion compared to the commercial products.

Air Permeability

Air permeability data was obtained for Examples 5, 8 and 9 and for the Odor Eater™ and Stainmaster™ commercial carpet cushion products. Two Stainmaster™ carpet cushions types were tested (rebond foam and prime foam). For comparison, data was also obtained on rebond foam only (i.e., no barrier layer). Air permeability was measured using a Frazier low pressure air permeability instrument according to the procedures of ASTM methods D 737-04 and D 737-96, except that the samples were masked with adhesive tape so that air flow only occurred through a 1 inch (2.54 cm) diameter section in the center of each 2.65 inch (6.73 cm) diameter punched sample. Air permeability data is given in Table 3.

TABLE 3

| | Foam thickness | Air Permeability |
|---|---|---|
| Sample | (mm) | (cfm/ft²) |
| Example 8 | 11.9 | 160.4 |
| Example 5 | 11.9 | 66.4 |
| Example 9 | 11.9 | 43.2 |
| Odor Eater ™ | 11.1 | 12.0 |
| (with prime foam) | | |
| Stainmaster ™ | 11.9 | 2.2 |
| (with rebond foam) | | |
| Stainmaster ™ | 10.3 | <1.0 |
| (with prime foam) | | |
| Polyurethane rebond foam | 11.9 | 287.4 |
| (no barrier layer) | | |

The carpet cushion constructions having a nonwoven as the barrier layer exhibited a significant advantage in air flow through the carpet cushion compared to the commercial products.

Liquid Extraction from Carpet

The purpose of these tests were to determine what amount of free and bound liquid could be extracted from a carpet/polyurethane foam construction and to identify a preferred extraction method (vacuuming vs. blotting). The first experiment involved extracting liquid from the two different areas of the carpet/polyurethane foam construction that were secured two a plywood board. Initially, each 12 inch×12 inch construction had 100 grams of water administered to the carpet surface, which was allowed to absorb for 15 minutes. After 15 minutes, samples were weighed (accounting for evaporation) and vacuumed with an industrial size vacuum 9 times in alternating directions. The samples were then weighed once more. The data (in grams) are given in Table 4.

TABLE 4
Liquid extracted from carpet surface (in grams)

| | Initial | Final | Extraction |
|---|---|---|---|
| Sample | weight | weight | weight |
| Example 8 | 1101.7 | 1038.8 | 62.9 |
| Odor Eater ™ | 1067.1 | 1012.3 | 54.8 |
| (with prime foam) | | | |
| Stainmaster ™ | 1086.6 | 1034.0 | 52.6 |
| (with prime foam) | | | |
| Polyurethane Rebond Foam | 1092.6 | 1019.5 | 73.1 |
| (no barrier layer) | | | |

Another set of 12 inch×12 inch (30.5 cm×30.5 cm) constructions had 100 grams of water administered to the foam of the cushion from the unprotected underside, which was allowed to absorb for 15 minutes. Next, the samples were weighed, the carpet/cushion/subfloor construction was reassembled, and the carpet surfaced vacuumed (as above). The samples were then weighed once more. The data (in grams) are given in Table 5.

TABLE 5
Liquid extracted from polyurethane
foam via carpet surface in grams

| | Initial | Final | Extraction |
|---|---|---|---|
| Sample | weight | weight | weight |
| Example 8 | 1037.8 | 1000.7 | 37.1 |
| Odor Eater^{R} Carpet Cushion | 1011.4 | 996.2 | 15.2 |
| (with prime foam) | | | |
| Stainmaster ™ Carpet Cushion | 1059.3 | 1055.6 | 3.7 |
| (with prime foam) | | | |
| Polyurethane Rebond Foam | 1063.7 | 1015.6 | 48.1 |
| (no barrier layer) | | | |

What is claimed:

1. A carpet cushion comprising a) a fibrous barrier layer having first and second major surfaces and b) a base layer having first and second major surfaces, wherein said barrier layer is bonded to one of said major surfaces of said base layer and said carpet cushion exhibits a Static Water Repellency Rating of at least 0, a Water Resistance (Hydrostatic Head) of at least 15 cm water, and an MVTR at 70° F. and 50% RH of at least 1000 grams/yard²/24 hours.

2. The carpet cushion of claim 1 wherein said carpet cushion exhibits a Static Water Repellency Rating of at least 1, a Water Resistance (Hydrostatic Head) of at least 40 cm water, and an MVTR at 70° F. and 50% RH of at least 2000 grams/yard²/24 hours.

3. The carpet cushion of claim 1 wherein said carpet cushion exhibits a Static Water Repellency Rating of at least 2, a Water Resistance (Hydrostatic Head) of at least 50 cm water, and an MVTR at 70° F. and 50% RH of at least 3000 grams/yard²/24 hours.

4. The carpet cushion of claim 1 wherein said barrier layer is substantially free of fluorochemical.

5. The carpet cushion of claim 1 wherein said carpet cushion is substantially free of fluorochemical.

6. The carpet cushion of claim 1 wherein said barrier layer comprises one or more materials to prevent or suppress the growth of mold, mildew, or bacteria, or to prevent or absorb odor.

7. The carpet cushion of claim 1 wherein said base layer comprises one or more materials to prevent or suppress the growth of mold, mildew, or bacteria, or to prevent or absorb odor.

8. The carpet cushion of claim 1 wherein said carpet cushion is wound into roll form.
